(19) United States
(12) Patent Application Publication
(10) Pub. No.: US 2006/0004883 A1
(43) Pub. Date: Jan. 5, 2006

(54) Encryption/decryption method incorporated with local server software

(76) Inventors: Hung-Te Chou, Shu Lin City (TW); Chi-Hsin Yu, I Lan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/973,624

(22) Filed: Oct. 26, 2004

(30) Foreign Application Priority Data
May 18, 2004 (TW) 93113986
May 18, 2004 (TW) 9320948020

(51) Int. Cl. G06F 17/30

(52) U.S. Cl. 707/201

(57) ABSTRACT

A document decryption/encryption method is incorporated with local server software for dynamically decrypting a document when the document is read. The method packages the document by encrypting the document with encryption software, attaches a local server software with the encrypted document so as to generate a corresponding package file having the local server program and the encrypted document together, and executes the package file by a local host. A local server program is provided by executing the local server software and loading the server program into the system memory of the local host, and the document is dynamically decrypted by the local server program when the document is read by a reading device associated with the local server program so as to open the document.

### BACKGROUND OF THE INVENTION

1. Field of the Invention

The present invention relates to an encryption/decryption method that uses local server software for preserving the privacy of a document.

2. Description of Related Art

With information networks becoming more and more popular, the security protection standard for shared documents on networks becomes higher and higher. The format of shared documents, such as HTML, XML or PDF, can usually be displayed by utilizing web browsers such as IE or Netscape. When users browse the document on line, network servers provide an encryption or authentication mechanism to the document or the data transmitted through the network so as to prevent any data interceptions from third parties. Even if third parties intercept packets or invade servers to obtain the encrypted document or data, they still cannot successfully read plain codes of the document or data under various encryption mechanisms.

However, for the purpose of providing users with expedient browsing, browsers on local hosts often provide a cache service. Accordingly, documents read on-line will have corresponding copies thereof stored on local hosts. These copied documents have no connection with the original servers when they are read off-line, that is, they have no privacy or security protection as originally provided by the servers. As a result, it's easy for third parties to have illegal access to these documents through directories of these copied documents on local hosts.

Please refer to FIG. 1, which is a schematic diagram illustrating browsing of a network document. Users browse the network documents through the reading device 19, preferably a web browser, in a computer 18. Documents for reading are always stored in the server 13 connected with other servers or user end machines through the Internet 15. The server 13 has a large-volume storage device, such as hard drives, CD-ROMs, or DVD-ROMs to store a database 11 so as to allow users to download data or documents from the database 11 to their machines or connect directly to the server for the purpose of reading or viewing. If users want to browse these documents off-line, they have to download these documents to the storage device 17 of local machines. Because the off-line browsing has no connection with the server 13, the privacy and security provided by the server 13 at the time of connection no longer exists at this point. Even if users choose to browse documents on-line (by connecting the server 13 through the network 15), they still need to download documents to the system memory of local machine from the database 11 and corresponding copies will be stored in the cache memory, which is a specific directory in the hard drive of the local machine. Therefore, these documents or data are still subject to illegal invasion by third parties.

### SUMMARY OF THE INVENTION

It is therefore a primary objective of the present invention to provide an encryption/decryption method that uses local server software not only applicable to documents read off-line but also to other shared files retrieved in other ways, rather than being read on-line or off-line. The present invention includes a function for document/file privacy protection equivalent to that possessed by the network server and thus has no concern for having copies of these documents or files stored in the local machine. In other words, the present invention encryption/decryption method incorporates an executable server program on local machines so as to dynamically decrypt the encrypted documents at the time they are read.

In accordance with the claimed invention, the present invention method includes steps as follows: creating a package document by encrypting the document with encryption software; attaching local server software to the packaged document so as to generate a corresponding package file with respect to the packaged document; opening the package file and executing the package file by a local host; providing a local server program by executing the local server software and loading the server program to the system memory of the local host; and dynamically decrypting the document by the local server program at the time the document is read by a reading device associated with the local server program in order to open the document.

The present invention also provides an alternative for executing the local server software before reading the encrypted document encrypted by the encryption software. By doing so, the local server program will be generated and then loaded into the system memory of the local host accordingly. The encryption software provides an encryption algorithm corresponding to a decryption algorithm in the local server software so as to have the local server software dynamically decrypt the encrypted documents and serves the purpose of securing the privacy of the local document.

It is an advantage of the present invention that having a local executable server program for dynamically decrypting a portion of encrypted documents until (or at the time) that portion of the document is read. The present invention further provides an authentication mechanism in conjunction with the local executable server program so as to provide an encryption measure substantially equivalent to that generally provided by the network servers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing a conventional scheme for network document browsing;

FIG. 2 is a schematic diagram showing the necessary components in the encryption/decryption method according to the present invention;

FIG. 3A is an operational flow chart on the part of encryption showing a first preferred embodiment according to the present invention;

FIG. 3B is an operational flow chart showing the decryption of the first preferred embodiment method based on the present invention;

FIG. 4A an operational flow chart on the part of encryption showing a second preferred embodiment according to the present invention; and

FIG. 4B is an operational flow chart showing the decryption of the first preferred embodiment method based on the present invention.

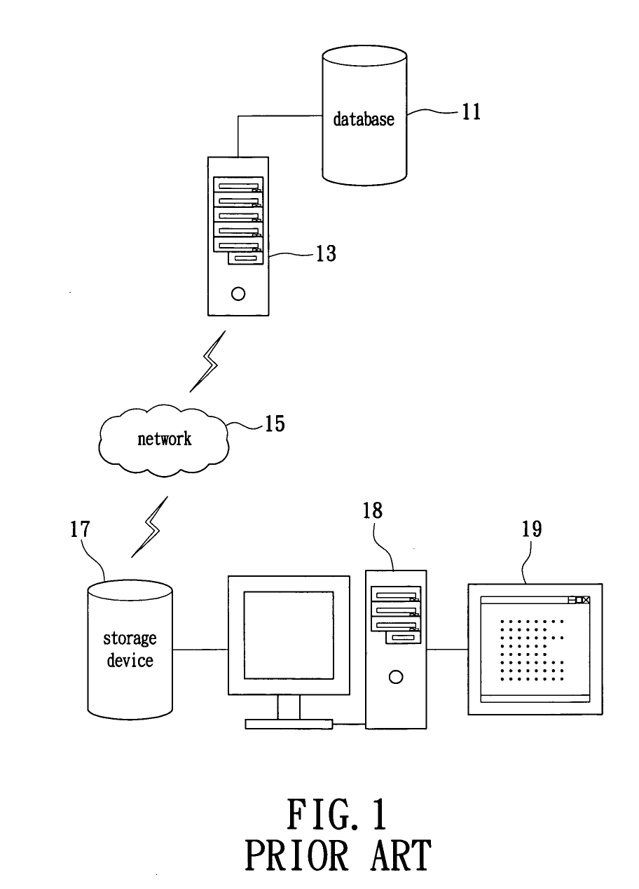

### DETAILED DESCRIPTION OF THE PREFERRED EMBODIMENTS

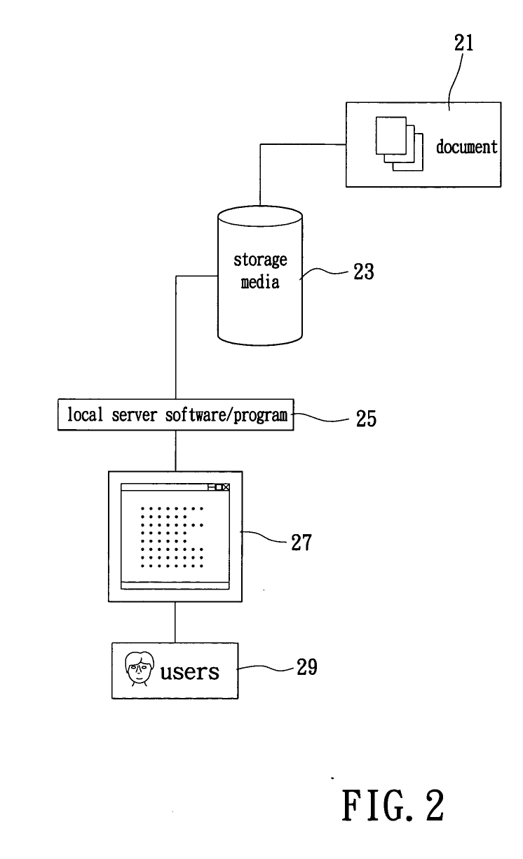

The present invention discloses an encryption/decryption method incorporating local server software. Reference is made to FIG. 2 of a schematic diagram showing the major components of the preferred embodiment according to the present invention. The document 21 is stored in a storage media 23 such as the hard drive, optical disc or others. Before being transferred to the local host, the document 21 is encrypted and packaged as a corresponding package file including local server software 25 therein. The local server software 25 is transmitted with the document 21 and has the decryption algorithm corresponding to the encryption algorithm in the encryption software.

The local host opens the package file, and then the local server software 25 transmitted together with the package file will be executed or decompressed. The execution of the local server software 25 generates a local server program 25 in the system memory of the local host. The local server program 25 serves as a daemon program in the system memory. When users 29 use a reading device 27 to open the document 21 stored in the storage media 23, a linking relationship between the reading device 27 and the local server program 25 is established. In other words, at the time of reading the document 21, the associated local server program 25 will decrypt the encrypted document 21 via the linking relationship for further reading. Meanwhile the local server program 25 will disable the cache memory mechanism in the local host for preventing copies of the document from being stored in the storage media of the local host. The document 21 is a web-formatted document such as a HTML-formatted document, and the reading device 27 preferably is a web browser such as IE or Netscape. At the time the encryption software encrypts the document, the encryption will be implemented with a varying value derived from a password. As the result, the document opening further requires the inputting of the password under this kind of authentication mechanism.

In another embodiment of the present invention, the package file of the document 21 includes no local server software 25. In this embodiment, the local server software 25 will be executed before opening the encrypted document 21 so as to generate a corresponding local server program 25 in the system memory of the local host. Consequently, the reading device 27 can open the document 21 by associating with the local server program 25 via the linking relationship between the reading device 27 and the local server program 25 when the document 21 is read.

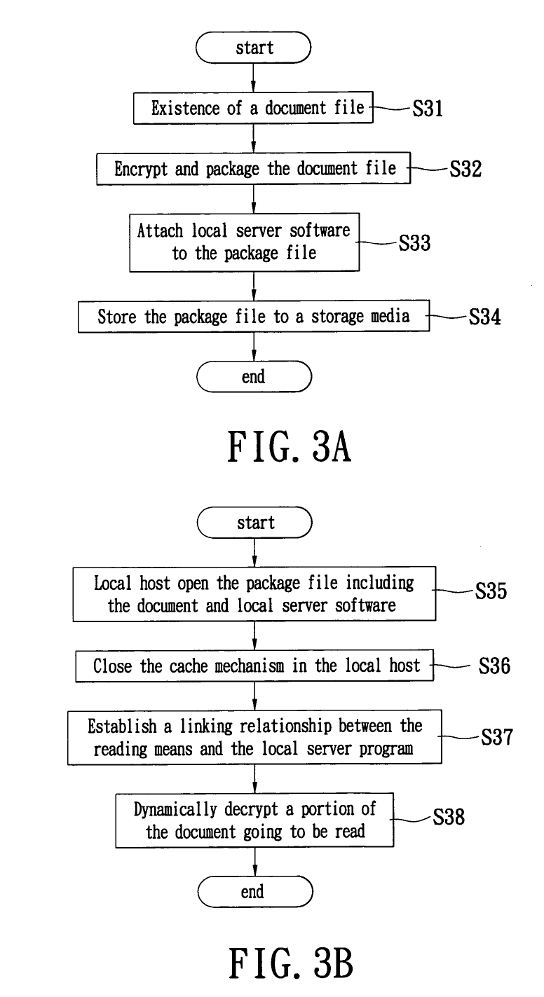

Reference is made to FIG. 3A of an operational flow chart of a first embodiment according to the present invention method. FIG. 3A discloses the encryption and decryption for documents. The present invention method includes the existence of a document file such as a web-formatted document (HTML or XML), an ordinary document file (TXT, PDF, JPG or GIF), or a specific document file generated by corresponding specific software (S31). Thereafter the encryption software packages the document file by a varying value derived from a pre-configured password. By this authentication mechanism, the document will be opened only the pre-configured password is entered (S32).

At the time of encryption and packaging of the document, local server software will be attached to the corresponding package file of the document. The package file includes, but is not limited to, an executable file in Windows operation systems (S33). After the package file is stored in a storage media (S34), the encryption of the document is complete. The package file is transferred to users who want to read the document or duplicated in the storage media of a local host.

FIG. 3B discloses operational flows for decryption steps based on the embodiment illustrated in FIG. 3A. The local host first opens the package file including the document and local server software (S35). The steps of opening the package file include decompression and decryption. An authentication step is added at this point. In other words, a correct password is required for successfully opening the package file. Once the authentication step is satisfied, the local server software generates a corresponding local server program in the system memory of the local host. The local server program is a daemon program and has a decryption algorithm corresponding to the encryption algorithm in the encryption software for encrypting the document. Additionally, the cache mechanism will be disabled in order to avoid copies of the document being stored in the cache (S36).

A reading device such as a web browser or reading software corresponding to the formats of the documents will be opened thereafter. A linking relationship is established between the reading device and the local server program (S37). At the time the document is read the reading device associated with the local server program opens the document and the local server program serves to dynamically decrypt the document. Taking the web-formatted document as an example, only the portion of the document currently being read is decrypted to secure the privacy of the document. Further, the cache mechanism is disabled and thus no copies of the document are stored in the local host (S38). At this point the decryption step is complete.

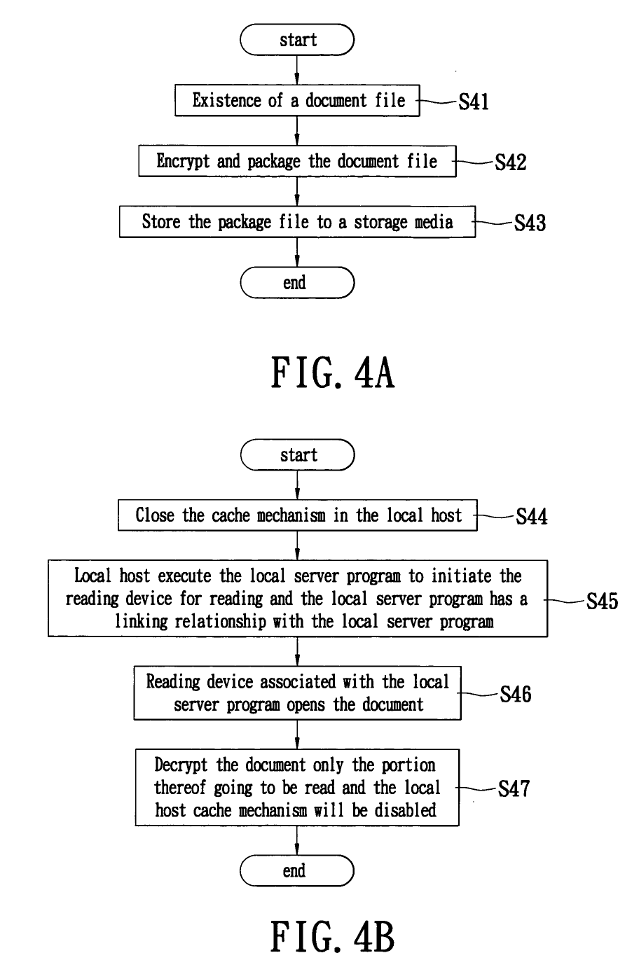

FIG. 4A shows a second embodiment of the present invention. The difference in FIGS. 4A and 3A is that the local server software is not included in the package file and will be executed in the local host instead. Operational flows in this embodiment include the existence of a document such as the HTML/XML-formatted or an ordinary document (S41). The encryption software packages the document by encrypting the document with respect to a varying value derived from a password. Therefore the opening of the document requires that the password be input. In the wake of encrypting the document, a corresponding package file is generated. The package file is not limited to an executable Windows file or a specific-formatted document file (S42). The encryption of this embodiment is finished after the package file is stored in the storage media (S43).

The decryption steps in the second embodiment are shown in FIG. 4B. The local host executes the local server software for generating a corresponding local server program in the system memory of the local host. The local server program is a daemon program and includes a decryption algorithm corresponding to the encryption algorithm of the encryption software. Meanwhile, the cache mechanism of the local host is disabled so that no copies of the document are stored in the cache of the local host (S44).

The local host includes a reading device for reading the document or opening the package file. The steps of opening the package file include decompression and decryption. An authentication step is added at this point. In other words, a correct password is required for successfully opening the package file. The reading device is preferably a web browser or reading software fit for the reading of the specific-formatted document. The reading device establishes a linking relationship with the local server program (S45). Therefore, at the time the reading device reads the document, the local server program associated with the reading device helps open the document (S46).

At the time the local server program decrypts only the portion of the document that is currently being read and the local host cache mechanism is disabled so that no copies remain on the local host (S47).

To sum up, the present invention provides an encryption/decryption method incorporating local server software. By dynamically decrypting the document going to be read with the use of local executable server program and the addition of an authentication process, the method of the present invention provides an encryption effect substantially equal to that which network servers provide.

Those skilled in the art will readily observe that numerous modifications and alterations of the device may be made while retaining the teachings of the invention. Accordingly, the above disclosure should be construed as limited only by metes and bounds of the appended claims.

What is claimed is:

1. A document decryption/encryption method incorporated with local server software for dynamically decrypting a document when the document is read, comprising the steps of:
creating a packaged document by encrypting the document with encryption software;
attaching local server software to the packaged document and then generating a corresponding package file having the attached local server software and the packaged document together;
opening the package file and executing the package file by a local host;
providing a local server program by executing the local server software and loading the server program into a storage media of the local host; and
dynamically decrypting the document by the local server program when the document is read by a reading means associated with the local server program so as to open the document.

2. The method as claimed in claim 1, wherein the reading means is a web browser.

3. The method as claimed in claim 1, wherein the document is a web-formatted document.

4. The method as claimed in claim 1, wherein the package file is an executable file.

5. The method as claimed in claim 1, wherein when the document is read, a linking relationship between the reading means and the local server program is established.

6. The method as claimed in claim 1, wherein when providing the local server program, the local server software disables a cache mechanism of the local host.

7. The method as claimed in claim 1, wherein when encrypting the document with the encryption software, the encryption software provides an encryption algorithm corresponding to a decryption algorithm of the local server software.

8. The method as claimed in claim 1, wherein when encrypting the document with the encryption software, the encryption of the document is executed with respect to a varying value derived from a password.

9. A document decryption/encryption method incorporated with local server software for dynamically decrypting a web-formatted document when the document is read, comprising the steps of:
creating a packaged web-formatted document by encrypting the web-formatted document with encryption software;
attaching local server software to the packaged web-formatted document so as to generate a corresponding package file having the attached local server software and the packaged web-formatted document together;
opening the package file and executing the package file by a local host;
providing a local server program by executing the local server software and loading the server program into a storage media of the local host; and
dynamically decrypting the web-formatted document by the local server program when the web-formatted document is browsed by a web browser associated with the local server program so as to open the web-formatted document.

10. The method as claimed in claim 9, wherein when browsing the web-formatted document, a linking relationship between the web browser and the local server program is established.

11. The method as claimed in claim 9, wherein when encrypting the web-formatted document with the encryption software, the encryption software provides an encryption algorithm corresponding to a decryption algorithm of the local server software.

12. The method as claimed in claim 9, wherein when providing the local server program, the local server software disables a cache mechanism of the local host.

13. The method as claimed in claim 9, wherein when encrypting the web-formatted document with the encryption software, the encryption of the web-formatted document is executed with respect to a varying value derived from a password.

14. A document decryption/encryption method incorporated with local server software for dynamically decrypting a document when the document is read, comprising the steps of:
creating a packaged document by encrypting the document with encryption software;
storing the package file in a storage media;
executing local server software so as to generate a local server program in a local host;
applying a reading means wherein a linking relationship between the reading means and the local server program is established; and
dynamically decrypting the package file by the local server program when the document is read by the reading means associated with the local server program so as to open the package file.

15. The method as claimed in claim 14, wherein the reading means is a web browser.

16. The method as claimed in claim 14, wherein the document is a web-formatted document.

17. The method as claimed in claim 14, wherein when the document is read, a linking relationship between the reading means and the local server program is established.

18. The method as claimed in claim 14, wherein when generating the local server software, the local server software disables a cache mechanism of the local host.

19. The method as claimed in claim 14, wherein when encrypting the document with the encryption software, the encryption software provides an encryption algorithm corresponding to a decryption algorithm of the local server software.

20. The method as claimed in claim 14, wherein when encrypting the document with the encryption software, the encryption of the document is executed with respect to a varying value derived from a password.
